(19) United States
(12) Patent Application Publication
(10) Pub. No.: US 2022/0418076 A1
(43) Pub. Date: Dec. 29, 2022

(54) LOW-VOLTAGE PLASMA IONIZER

(71) Applicants: EM CORETECH CO., LTD., Ulsan (KR); UNIST (ULSAN NATIONAL INSTITUTE OF SCIENCE AND TECHNOLOGY), Ulsan (KR)

(72) Inventors: Jin Gook KIM, Ulsan (KR); Byung Jin BAE, Ulsan (KR)

(21) Appl. No.: 17/821,893

(22) Filed: Aug. 24, 2022

Related U.S. Application Data
(63) Continuation-in-part of application No. PCT/KR2020/013948, filed on Oct. 13, 2020.

(30) Foreign Application Priority Data
Feb. 24, 2020 (KR) 10-2020-0022412

(51) Int. Cl. H05H 1/24; H01T 23/00

(52) U.S. Cl. CPC H05H 1/2481; H01T 23/00

(57) ABSTRACT

A low-voltage plasma ionizer is proposed. The ionizer may include a resonator module comprising a metal plate and configured to generate plasma by using an electric field, wherein the metal plate comprises a long side extending in a longitudinal direction, a short side crossing the long side, and a slot extending in the longitudinal direction. The ionizer may also include a source generator connected to the resonator module, and configured to supply a signal to the resonator module to generate plasma including plasma ions around the metal plate. The ionizer may further include a fan placed in an XY plane, and configured to move the plasma ion in a direction crossing the XY plane.

### CROSS REFERENCE TO RELATED APPLICATIONS

This is a continuation-in-part application of International Patent Application No. PCT/KR2020/013948, filed on Oct. 13, 2020, which claims priority to Korean patent application No. 10-2020-0022412 filed on Feb. 24, 2020, contents of each of which are incorporated herein by reference in their entireties.

### BACKGROUND

### Technical Field

Embodiments of the disclosure relate to a low voltage plasma ionizer.

### Description of the Related Technology

An ionizer is a device that neutralizes static electricity by using air ions, and is used in various facilities that require static electricity prevention, such as semiconductor processes.

### SUMMARY

An objective of the disclosure for solving the above problems is to provide a plasma ionizer that facilitates the design and use of an electrode by using a slot electrode and an arrangement thereof, and optimizes antistatic performance.

In addition, an objective of the disclosure is to provide a plasma ionizer capable of igniting plasma through an additional stimulus or substance without inert gas.

A plasma ionizer according to an embodiment of the disclosure includes a resonator module including a metal plate and generating plasma by using an electric field, wherein the metal plate includes a long side extending in a longitudinal direction, a short side crossing the long side, and a slot extending in the longitudinal direction; a source generator connected to the resonator module, and supplying a signal to the resonator module to generate plasma including plasma ions around the metal plate; and a fan placed in an XY plane, and provided to move the plasma ion in a direction crossing the XY plane.

The fan includes a first surface parallel to the XY plane, and a second surface parallel to the XY plane and facing the first surface, a wind generated by the fan blows downward of the second surface from the first surface, and the metal plate may be located above the first surface of the fan.

The resonator module includes a plurality of the metal plates, and the plasma ionizer may further include a power divider distributing and transmitting the signal to each of the plurality of metal plates.

The plurality of metal plates includes a first metal plate and a second metal plate, the first metal plate includes a first long side and a first short side crossing the first long side, the second metal plate includes a second long side and a second short side crossing the second long side, and an extension line of the first short side and an extension line of the second short side each may have an inclination angle of 0 degrees or more and less than 180 degrees with respect to the XY plane.

The plurality of metal plates includes four metal plates spaced apart from each other at a predetermined interval, each of the four metal plates includes a long side and a short side crossing the long side, and extension lines of the short sides of each of the four metal plates may have an inclination angle of 0 degrees or more and less than 180 degrees with respect to the XY plane.

The plasma ionizer further includes a piezoelectric element disposed on one end of the metal plate, and may ignite the plasma by applying a pressure to the one end through the piezoelectric element.

The metal plate includes a first electrode and a second electrode facing each other with the slot therebetween, and the metal plate may further include a conductive material layer coated on one end of each of the first electrode and the second electrode adjacent to the slot.

A plasma ionizer according to embodiments of the disclosure may easily use and design an electrode by using a slot electrode and various arrangements thereof, and may dramatically improve antistatic performance.

In addition, the plasma ionizer may ignite plasma through various methods, such as using an additional stimulus or material, without an inert gas.

### BRIEF DESCRIPTION OF THE DRAWINGS

FIG. 1 is a block diagram schematically illustrating a configuration of a plasma ionizer according to an embodiment of the disclosure.

FIG. 2 is a view illustrating a resonator module according to an embodiment of the disclosure in more detail.

FIG. 3 is a perspective view illustrating a configuration of a plasma ionizer according to an embodiment of the disclosure in three dimensions.

FIGS. 4A to 4D are side views viewed from one direction of a resonator module in which long sides of metal plates according to an embodiment of the disclosure are disposed at different inclination angles.

FIGS. 5A and 5B are graphs in which decay times are measured for each of the embodiments of FIGS. 4A to 4D.

FIG. 6 is a perspective view three-dimensionally illustrating a configuration of a plasma ionizer according to another embodiment of the disclosure.

FIGS. 7A and 7B are side views viewed from different directions of a resonator module in which short sides of metal plates are disposed at an angle according to an embodiment of the disclosure.

FIGS. 8A and 8B are side views viewed from different directions of a resonator module having short sides of metal plates disposed at different angles according to an embodiment of the disclosure.

FIGS. 9A and 9B are graphs in which decay times are measured for the embodiments of FIGS. 7A, 7B, 8A and 8B.

FIG. 10 is a side view illustrating an arrangement of a metal plate and a fan according to an embodiment of the disclosure.

FIG. 11 is a side view illustrating an arrangement of a metal plate and a fan according to another embodiment of the disclosure.

FIGS. 12A and 12B are graphs in which decay times are measured with respect to the embodiments of FIGS. 10 and 11.

FIG. 13 is a perspective view three-dimensionally illustrating a configuration of a plasma ionizer according to another embodiment of the disclosure, and is an example of a multi-slot structure.

FIGS. 14A and 14B are top views schematically illustrating the ionizer of FIG. 13 as viewed from one side and an upper surface.

FIGS. 15A and 15B are side views of an ionizer according to another embodiment of the disclosure as viewed from an YZ plane.

FIGS. 16A to 16C are top views of an arrangement of a metal plate according to different embodiments of the disclosure as viewed from an XY plane.

FIG. 17 is a perspective view three-dimensionally illustrating a configuration of a plasma ionizer according to another embodiment of the disclosure, which is another example of a multi-slot structure.

FIG. 18 is a top view schematically illustrating the ionizer of FIG. 17 as viewed from the top.

FIGS. 19A and 19B are graphs comparing and measuring decay times with respect to the embodiments of FIGS. 6 and 13.

FIG. 20 is a diagram schematically illustrating a configuration of a plasma ionizer according to another embodiment of the disclosure.

FIG. 21 is a diagram schematically illustrating a configuration of a plasma ionizer according to another embodiment of the disclosure.

### DETAILED DESCRIPTION

There are corona discharge type ionizers and light irradiation type ionizers according to a method of separating air molecules in these ionizers.

The corona discharge type ionizer generates and discharges a high voltage at a tip of an electrical conductor, and electrons collide with nearby air ions to generate air ions near the tip of the conductor.

The light irradiation type ionizer uses weak X-rays to break up molecules in the air, thereby generating a large amount of air ions. This light irradiation type ionizer requires sufficient care and special blocking equipment when used to prevent damage to a human body by X-rays.

In addition, a plasma process of a low-pressure process (or a vacuum process) that requires a complex and expensive system such as a vacuum chamber has been developed. Recently, an atmospheric pressure plasma process that may be implemented with a simple and low-cost system, that is not constrained to be in a vacuum environment, and that may generate plasma having the same or greater effect as vacuum plasma has been attracting attention.

Most plasma generating mechanisms are mainly performed using a method of transferring energy to charged particles through an electric field, and may be classified into direct current discharge, radio frequency (RF) discharge, microwave discharge, etc. according to a method of forming the electric field. A microwave plasma generation method is similar to a RF plasma generation method except for the frequency. Since the direct current discharge requires high voltage and high power, and has technical difficulties such as difficult conditions for maintaining discharge, alternating current discharge using a radio frequency, so-called RF discharge, has been developed.

However, RF discharge has a high risk of damage to an object to be treated by the temperature of the emitted plasma, is limited in electrode design, and has to use a high-frequency power supply, so there are limitations such as the requirement of high installation costs. On the other hand, the atmospheric pressure plasma is difficult to generate plasma without an inert gas such as Ar, He, Ne, or Xe.

A plasma ionizer according to an embodiment of the disclosure includes a resonator module including a metal plate and generating plasma by using an electric field, wherein the metal plate includes a long side extending in a longitudinal direction, a short side crossing the long side, and a slot extending in the longitudinal direction; a source generator connected to the resonator module, and supplying a signal to the resonator module to generate plasma including plasma ions around the metal plate; and a fan placed in an XY plane, and provided to move the plasma ion in a direction crossing the XY plane.

Since the disclosure may apply various transformations and can have various embodiments, specific embodiments are illustrated in the drawings and described in detail in the detailed description. Effects and features of the disclosure, and a method of achieving them will become clear with reference to the embodiments described below in detail in conjunction with the drawings. However, the disclosure is not limited to the embodiments disclosed below and may be implemented in various forms.

Hereinafter, embodiments of the disclosure will be described in detail with reference to the accompanying drawings, and when described with reference to the drawings, the same or corresponding components are given the same reference numerals, and overlapping descriptions thereof will be omitted.

In the following embodiments, terms such as first, second, etc. are not used in a limiting sense, but are used for the purpose of distinguishing one component from another. In the following examples, the singular expression includes the plural expression unless the context clearly dictates otherwise. In the following embodiments, terms such as include or have means that the features or components described in the specification are present, and the possibility that one or more other features or components will be added is not excluded in advance. In the drawings, the size of the components may be exaggerated or reduced for convenience of description. For example, since the size and shape of each configuration shown in the drawings are arbitrarily indicated for convenience of description, the disclosure is not necessarily limited to the illustrated one.

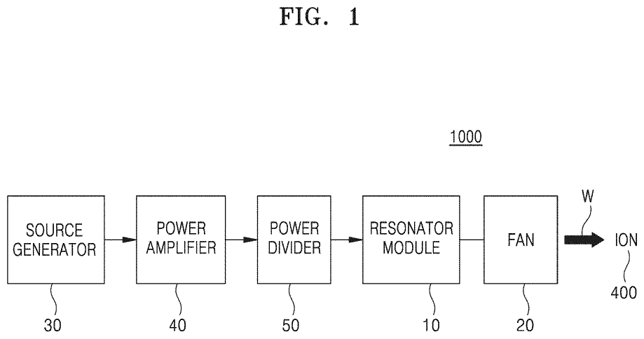

FIG. 1 is a block diagram schematically illustrating a configuration of a low voltage plasma ionizer according to an embodiment of the disclosure.

A low voltage plasma ionizer 1000 according to an embodiment may perform a surface treatment such as removing static electricity by neutralizing a charged surface by using air ions.

The ionizer 1000 according to an embodiment may include a source generator 30, a power amplifier 40, a power divider 50, a resonator module 10 and a fan 20.

The source generator 30 may generate an electrical signal and/or voltage needed to generate plasma. The source generator 30 may be a source generator of a RF or microwave.

The power amplifier 40 may amplify the signal and/or voltage generated by the source generator 30 to have sufficient power to generate plasma. Although not illustrated in the drawings, the source generator 30 and the power amplifier 40 may be provided as a single device.

When the resonator module 10 to be described later includes a plurality of resonators, the power divider 50 may distribute and transmit power to each of the plurality of resonators. According to an embodiment, the power divider 50 may be omitted.

The resonator module 10 may be a module for finally generating plasma by receiving the signal and/or voltage generated from the source generator 30. High-temperature electrons heated by an electric field generated by the source generator 30 ionize neutral air molecules to generate plasma, and at this time, the plasma may mean a concept including all of neutral, air ion 400 and electron. Hereinafter, the air ion of plasma may be named and described as plasma ion 400.

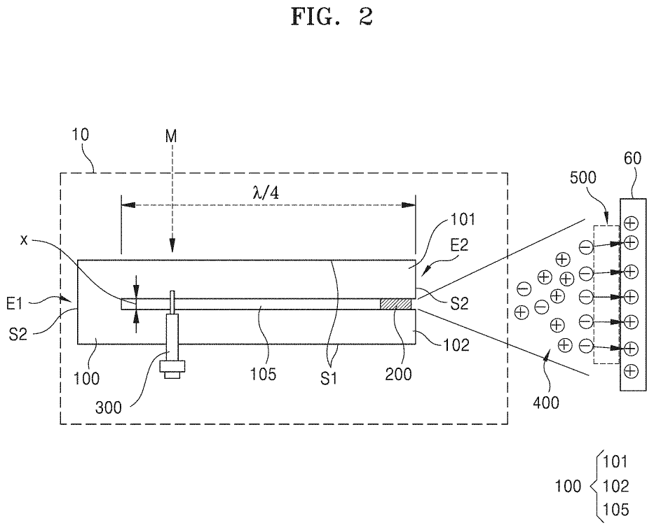

The resonator module 10 may include a single resonator or a plurality of resonators. Each resonator may include a metal having a slot to be described later. When the plurality of resonators are provided, the antistatic performance of the ionizer 1000 may be improved. The resonator module 10 will be described in more detail with reference to FIG. 2 to be described later.

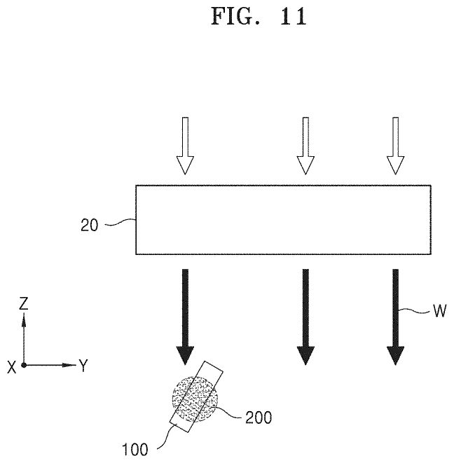

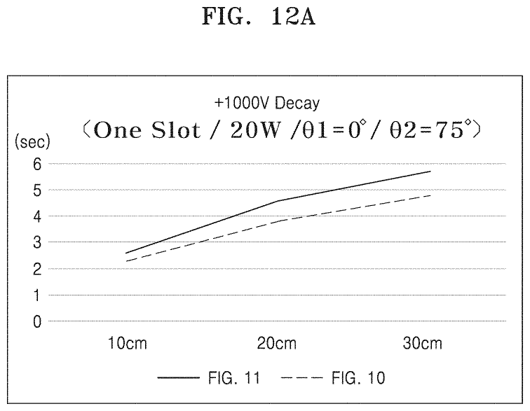

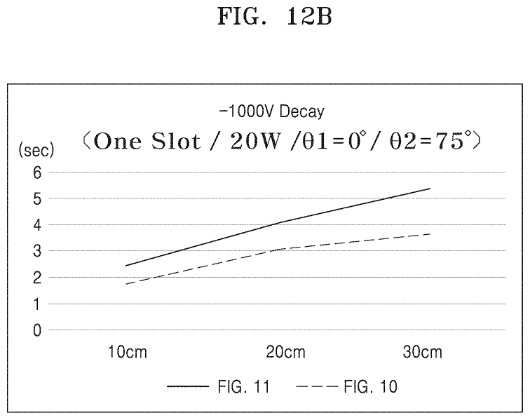

The fan 20 may generate wind W to move the plasma ion 400 generated by the resonator module 10. In order to prevent an intensity of plasma ignited from being weakened or extinguished by the wind generated by the fan 20, the fan 20 may be disposed in front of the resonator module 10. An arrangement of the fan 20 will be described in more detail with reference to FIGS. 10 to 12A and 12B to be described later. In addition, the fan 20 may also serve to cool the resonator module 10 heated due to plasma generation.

The plasma ion 400 generated by the resonator module 10 may neutralize and remove static electricity by reaching a surface where electric charges are accumulated through wind W generated by the fan 20.

Next, a configuration and principle of the resonator module 10 will be described with reference to FIG. 2. FIG. 2 is a view illustrating a resonator module 10 according to an embodiment of the disclosure in more detail. Hereinafter, the resonator module 10 will be called as a resonator 10 including a single metal plate 100.

The resonator 10 may include the metal plate 100 and a transmission conductor 300 connected to the metal plate 100.

The metal plate 100 may include a pair of long sides S1 extending in a longitudinal direction, a pair of short sides S2 crossing the long side S1, and a slot 105 extending in the longitudinal direction. The metal plate 100 may be divided into a first electrode 101 and a second electrode 102 by the slot 105. In other words, the first electrode 101 and the second electrode 102 may be disposed to face each other with the slot 105 interposed therebetween. The lengths of the first electrode 101 and the second electrode 102 may be ¼ times a wavelength A of the signal generated from the source generator 30. In FIG. 2, the lengths of the electrodes 101 and 102 are λ/4 as an example.

A width x of the slot 105 may be about 10 μm to about 200 μm, for example, about 100 μm, but is not limited thereto.

In the disclosure, a shape in which the metal plate 100 is bent into a shape similar to the alphabet C by the slot 105 is exemplified, but the shape of the slot 105 and the metal plate 100 formed thereby is not limited thereto.

In order to generate plasma around the slot 105, the transmission conductor 300 may be connected to the source generator 30 to supply the signal and/or voltage generated from the source generator 30 to the metal plate 100. The transmission conductor 300 may be connected to the source generator 30 through the power amplifier 40 and/or the power divider 50.

The transmission conductor 300 may be located on the metal plate 100 at an impedance matching point M with respect to the source generator 30 to be electrically or physically connected to the metal plate 100. The transmission conductor 300 may be disposed at the impedance matching point M to have an impedance of 500 with respect to a frequency 1/θ of the signal supplied from the source generator 30.

The metal plate 100 may include a first end E1 and a second end E2. The first end E1 may be a closed end not opened by the slot 105, and the second end E2 may be an open end opened by the slot 105.

In the slot 105, which is a space between the two electrodes 101 and 102 of the metal plate 100, plasma 200 may be generated by the signal and/or voltage supplied by the transmission conductor 300. Plasma 200 may be generated at the open end E2 of the metal plate 100. The plasma ion 400 included in the plasma 200 may reach one surface 60 of a charged object to remove static electricity. As illustrated by way of example in FIG. 2, negative electric charges of the plasma ion 400 may neutralize static electricity as shown 500 in FIG. 2, by combining with positive electric charges on the surface 60 where the positive electric charges are accumulated.

When the resonator module 10 includes a plurality of metal plates 100 (multi-slot structure), each of the plurality of metal plates 100 may have substantially the same configuration as the metal plate 100 described above.

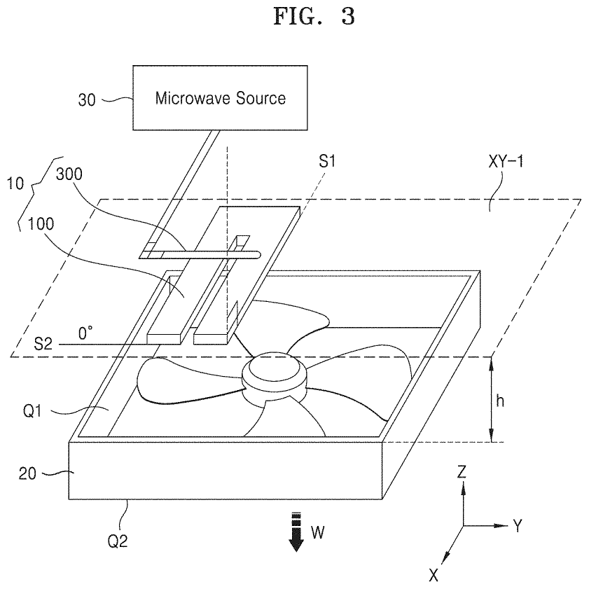

FIG. 3 illustrates a more specific embodiment of the ionizer. Hereinafter, descriptions of content overlapping with those described with reference to FIGS. 1 and 2 may be omitted or simplified.

Referring to FIG. 3, the source generator 30, the resonator 10 and the fan 20 among the components of the ionizer 1000 are illustrated. The resonator 10 may include the metal plate 100 and the transmission conductor 300 connected thereto.

The source generator 30 may supply the signal (e.g., microwave) for generating plasma to the metal plate 100 through the transmission conductor 300. In FIG. 3, the transmission conductor 300 is illustrated to be directly connected to the source generator 30, but the disclosure is not limited thereto, and although not illustrated in the drawings, the above-described power amplifier 40 and/or the power divider 50 may be further located between the source generator 30 and the transmission conductor 300.

The metal plate 100 and the fan 20 may be positioned parallel to an XY plane in a three-dimensional space, and may be spaced apart from each other by a distance h in a Z-axis direction. At this time, a plane spaced from the fan 20 in an upper direction of the Z-axis direction in parallel by the distance h among the XY planes is referred to as an XY-1 plane.

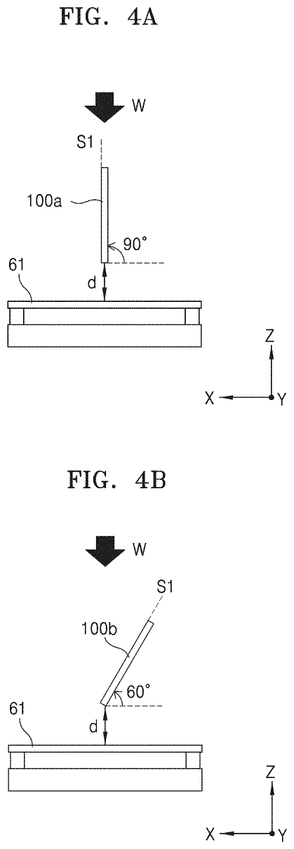

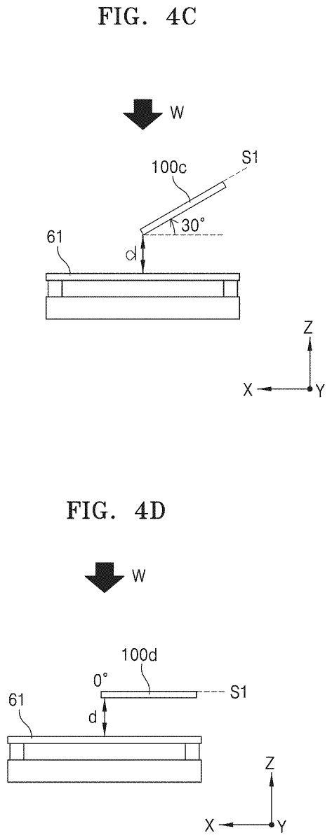

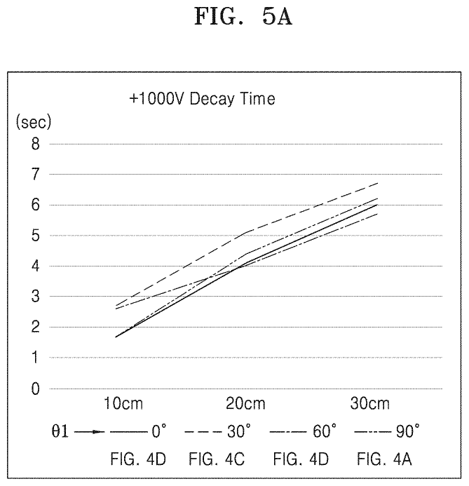

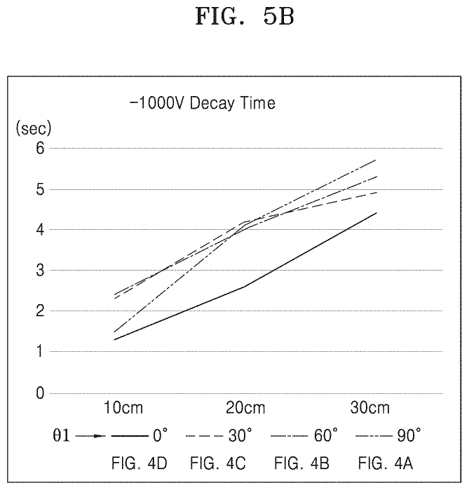

The metal plate 100 may include the pair of long sides S1 and the pair of short sides S2 crossing the long side S1. Hereinafter, the reference numerals S1 and S2 refer to extension lines of the long side and the short side, respectively, but for convenience of description, the extension lines may be omitted and described as the long side and the short side. In FIG. 3, only one long side S1 and one short side S2 are indicated for convenience of explanation. In the embodiment of FIG. 3, since the metal plate 100 is positioned on the XY-1 plane, both the long side S1 and the short side S2 are positioned on the XY plane. In other words, in the embodiment of FIG. 3, both the long side S1 and the short side S2 of the metal plate 100 are arranged at 0 degrees with respect to the XY plane. Such an embodiment is schematically illustrated in FIG. 4d.

The fan 20 may include a first surface Q1 parallel to the XY plane, and a second surface Q2 parallel to the XY plane and opposite to the first surface Q1. In other words, in FIG. 3, the first surface Q1 may be an upper surface of the fan 20, and the second surface Q2 may be a lower surface of the fan 20. The fan 20 may generate wind blowing from the first surface Q1 downward of the second surface Q2. The metal plate 100 may be positioned above the first surface Q1 of the fan 20.

FIGS. 4A to 4D are side views of a metal plate in which long sides of the metal plates according to an embodiment of the disclosure are disposed at different inclination angles viewed from one direction, and FIGS. 5A and 5B are graphs in which decay times are measured for each of the embodiments of FIGS. 4A to 4D.

Referring to FIGS. 4A to 4D, one side views of the metal plate 100; 100a, 100b, 100c and 100d according to an inclination angle θ1 of the long side S1 of the metal plate 100 with respect to the XY plane (hereinafter, a first inclination angle) are illustrated. The side views of FIGS. 4A to 4D are side views viewed from an Y direction. FIGS. 4A, 4B, 4C and 4D sequentially illustrate an embodiment in which the inclination angle θ1 of the long side S1 is 90 degrees, 60 degrees, 30 degrees, and 0 degrees. In the embodiments of FIGS. 4A to 4D, inclination angles 82 of the short sides S2 with respect to the XY plane (hereinafter, second inclination angles) are all 0 degrees.

In each embodiment, a charged plate monitor (CPM) device 61 for measuring antistatic performance is disposed below the metal plate 100 in the Z-axis direction. The CPM device 61 may include a plate on which the plasma ion 400 arrives from the metal plate 100. The CPM device 61 may test the antistatic performance of the ionizer 1000 by measuring a decay time. The decay time is measured in a way that measures time for which static electricity intentionally applied on the plate of the CPM device 61 is removed by using ions generated from the ionizer 1000. As an example, the time until the constant voltage drops to about 10% or less of the initial constant voltage may be measured.

Each of FIGS. 5A and 5B are graphs illustrating distributions of the decay time when +1000V and −1000V are applied as initial constant voltages for each of the embodiments of FIGS. 4A to 4D (that is, the time until the respective constant voltages will be +100 V and −100 V). Assuming that a lowest point of the metal plate 100 is spaced apart from the plate of the CPM device 61 by a distance d, FIGS. 5A and 5B are graphs measuring the decay time according to the distance d. The distance d may be in a range of several cm to several tens of cm, but is not limited thereto.

Referring to FIGS. 5A and 5B, in general, the decay time is the smallest when the first inclination angle 61 is 0 degrees, so that it may be confirmed that the embodiment in which the long side S1 of the metal plate 100 is positioned parallel to the XY plane has excellent antistatic performance.

Specifically, referring to FIGS. 5A and 5B, when the distance d is about 10 cm to about 20 cm, the first inclination angle 61 is 0 degrees, 90 degrees, 60 degrees, and 30 degrees in the order that the antistatic performance may be excellent.

In particular, when the initial constant voltage of FIG. 5A is +1000V and the distance d is about 10 cm, and when the initial constant voltage of FIG. 5B is −1000V and the distance d is about 20 cm, the embodiment in which the first inclination angle 61 is 0 degrees has much better antistatic performance than other embodiments. For example, in FIG. 5A, when the distanced is 10 cm, the decay time of the embodiment in which the first inclination angle 61 is 0 degrees is about 1.7 to 1.8 seconds, which is reduced about 30% or more than the decay time of the embodiments in which the first inclination angle θ1 are 30 degrees and 60 degrees (about 2.7 seconds to about 2.8 seconds). In FIG. 5B, when the distance d is 20 cm, the decay time of the embodiment in which the first inclination angle θ1 is 0 degrees is about 2.5 seconds, which is about 40% lower than the decay time of the other embodiments (about 4 seconds before and after).

In summary, when the long side S1 of the metal plate 100 has the inclination angle of 0 degrees, that is, when it is arranged parallel to the XY plane, the antistatic performance of the ionizer 1000 may be the best. One of the reasons is that the plasma generated in the slot 105 has a largest area in contact with the wind when the first inclination angle θ1 is 0 degrees, assuming that the plasma is maintained stably.

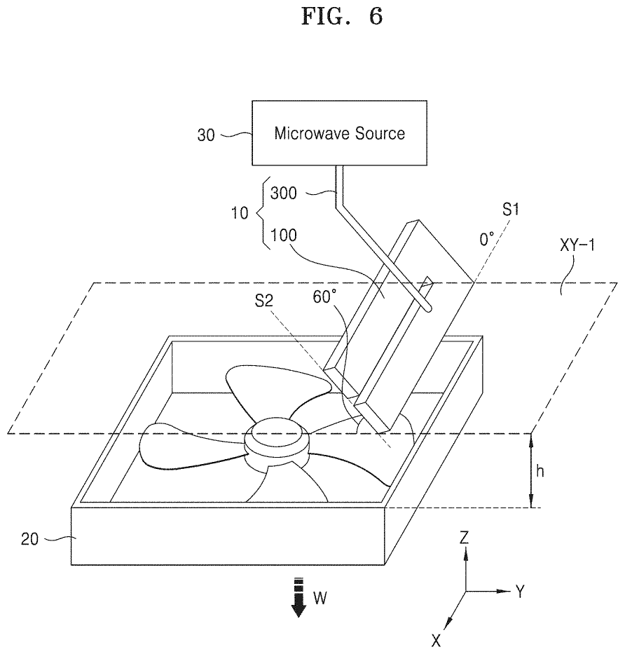

Hereinafter, an antistatic performance of an ionizer 1000 according to an arrangement of a short side S2 of a metal plate 100 according to another embodiment will be described with reference to FIGS. 6 to 9B. Hereinafter, the description of the content overlapping with the above-described content may be omitted or simplified.

First, FIG. 6 is a perspective view three-dimensionally illustrating a configuration of a plasma ionizer according to another embodiment of the disclosure. In the embodiment of FIG. 6, a metal plate 100 may be arranged such that a long side S1 is maintained in a fixed state on an XY plane (XY-1 plane) spaced apart from ae fan 20 by a distance h (θ1=0 degrees), and such that a short side S2 has an inclination angle greater than 0 degrees and less than 180 degrees with respect to the XY-1 plane. FIG. 6 illustrates an example in which a second inclination angle θ2 is 60 degrees.

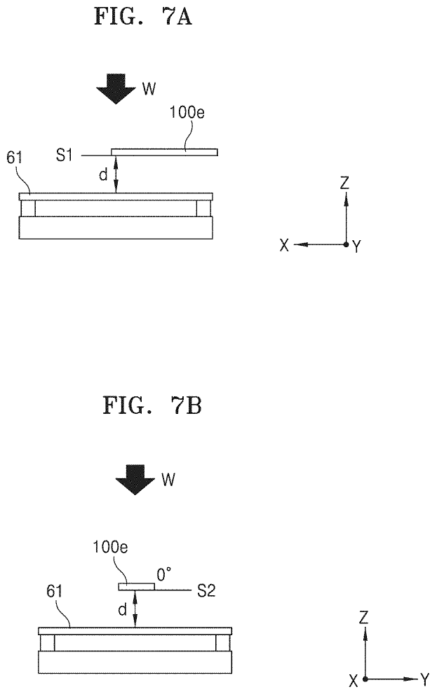

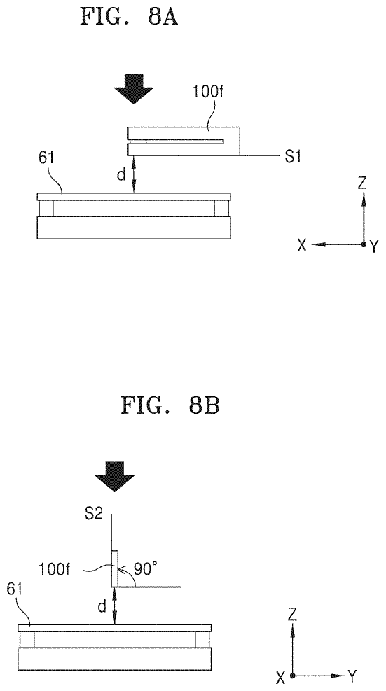

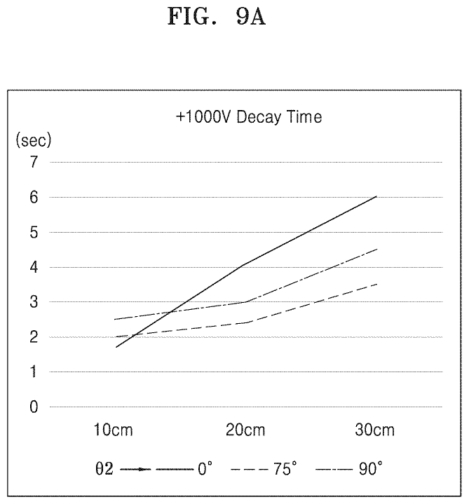

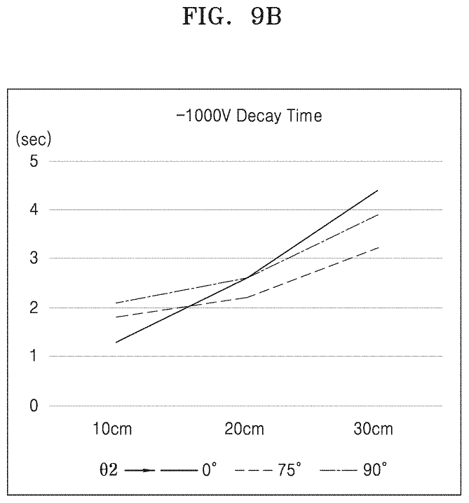

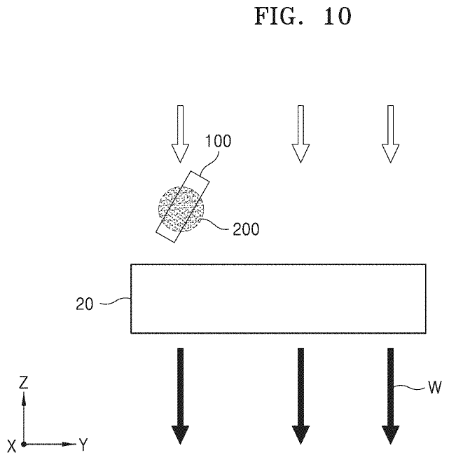

FIGS. 7A, 7B, 8A and 8B are respectively side views of a metal plate in which a short side S2 of a metal plate 100 according to an embodiment of the disclosure is arranged at 0 degrees and 90 degrees, respectively, viewed from different directions. FIGS. 9A and 9B are graphs in which decay times are measured for the embodiments of FIGS. 7A, 7B, 8A and 8B.

Referring to FIGS. 7A and 7B, the embodiment in which inclination angles 81 and 82 of a long side S1 and a short side S2 of a metal plate 100e are both 0 degrees (FIG. 3) is illustrated. With respect to this embodiment, FIG. 7A is a side view viewed from an Y-axis direction, in which the inclination angle θ1 of the long side S1 is arranged at 0 degrees, and FIG. 7B is a side view viewed from an X-axis direction, in which the inclination angle θ2 of the short side S2 is arranged at 0 degrees.

Referring to FIGS. 8A and 8B, an embodiment having a metal plate 100f in which an inclination angle θ1 of a long side S1 of is 0 degrees and an inclination angle θ2 of a short side S2 is all 90 degrees is illustrated. For this embodiment, FIG. 8A is a side view viewed from an Y-axis direction, illustrating a planar shape of the metal plate 100 including a slot 105, and FIG. 8B is a side view viewed from an X-axis direction, illustrating the inclination angle θ2 of the short side S2 is inclined by 90 degrees.

FIGS. 9A and 9B are graphs illustrating distributions of the decay time when +1000 V and −1000 V are applied as initial constant voltages for the embodiments having different second inclination angles 82, such as in FIGS. 7A to 8B.

Referring to FIGS. 9A and 9B, in general, the decay time is the smallest when the second inclination angle θ2 is inclined, so that it may be confirmed that the embodiment in which the short side S2 of the metal plate 100 is disposed to be inclined with respect to the XY plane has excellent antistatic performance.

Specifically, referring to FIGS. 9A and 9B, in a range where a distance d is about 10 cm to about 30 cm, antistatic performance may be excellent in the order of the second inclination angle θ2 of 75 degrees, 90 degrees, and 0 degrees.

In particular, in terms of antistatic performance, the distance d is advantageously in a range of about 12 cm to about 30 cm when the initial constant voltage of FIG. 9A is +1000 V, and the distance d may be advantageously in a range of about 20 cm to about 30 cm when the initial constant voltage of FIG. 9B is −1000V.

In summary, when the short side S2 of the metal plate 100 has the inclination angle θ2 of more than 0 degree and less than 90 degrees, that is, when it is arranged obliquely with respect to the XY plane, the antistatic performance of the ionizer 1000 may be the best. The inclination angle θ2 of the short side S2 may have a range of greater than 90 degrees and less than 180 degrees depending on a reference point to be measured.

One of the reasons is that, when the inclination angle θ1 of the long side S1 is 0 degrees, the antistatic performance is good, but there is a possibility that the plasma is weakened or extinguished by the influence of the wind, but the plasma may be stably maintained when the short side S2 is obliquely arranged.

In the conventional plasma ionizer, when generating RF plasma, it was difficult to design the electrode of the resonator. Accordingly, in the disclosure, it is possible to facilitate and simplify the use and design of the electrode, by using the metal plate 100 including the slot 105, that is, the slot electrode. As described above, the antistatic performance of the ionizer 1000 may be optimized by variously adjusting and disposing the inclination angles θ1 and θ2 of the long side S1 and the short side S2 of the slot electrode.

Hereinafter, an antistatic performance of an ionizer 1000 according to an arrangement of a metal plate 100 and a fan 20 according to an embodiment will be described with reference to FIGS. 10 to 12B. Hereinafter, the description of the content overlapping with the above-described content may be omitted or simplified.

FIG. 10 is a side view illustrating an arrangement of a metal plate 100 and a fan 20 according to an embodiment of the disclosure, in which the fan 20 is positioned below (or front) the metal plate 100 in a Z-axis direction, and FIG. 11 is an embodiment in which a fan 20 is positioned above (or behind) a metal plate 100 in a Z-axis direction. When viewed from the X-axis direction, the metal plate 100 may have a short side S2 obliquely disposed, and plasma 200 may be generated in the metal plate 100.

FIGS. 12A and 12B are graphs in which decay times are measured for the embodiments of FIGS. 10 and 11 (θ1=0 degrees, θ2=75 degrees), respectively. Referring to FIGS. 12A and 12B, when the fan 20 is positioned in front of the metal plate 100 (FIG. 10), the decay time is smaller, and thus it may be seen that the antistatic performance is better. This is because, assuming that an intensity of the fan 20, that is an intensity of the wind blowing out through the second surface Q2 of the fan 20 is the same, the intensity of the wind entering the first surface Q1 of the fan 20 is weaker than the intensity of the wind blowing out to the second surface Q2, so when the metal plate 100 is positioned in front of the fan 20, the plasma 200 is less affected by the wind.

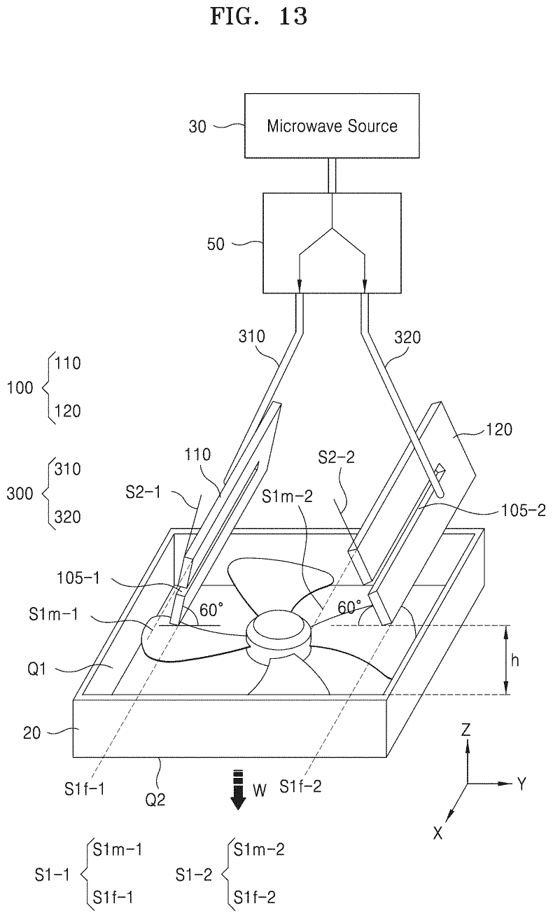

Hereinafter, a multi-slot structure of an ionizer according to an embodiment will be described with reference to FIGS. 13 to 18. Hereinafter, descriptions of content overlapping with the above-described content may be omitted or simplified, and descriptions may be made focusing on portions that are characteristic compared to the above-described embodiments. In the drawings below, for convenience of explanation, a portion in which plasma 200 is generated is illustrated in a circle.

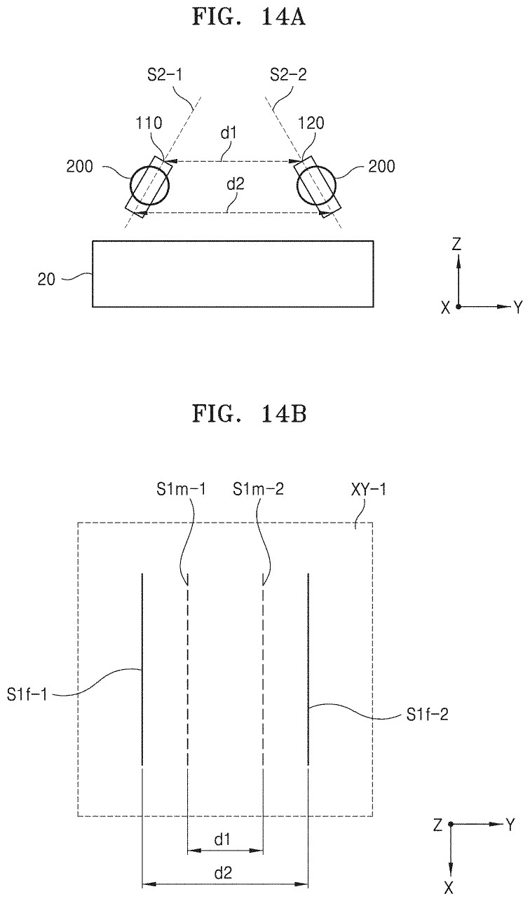

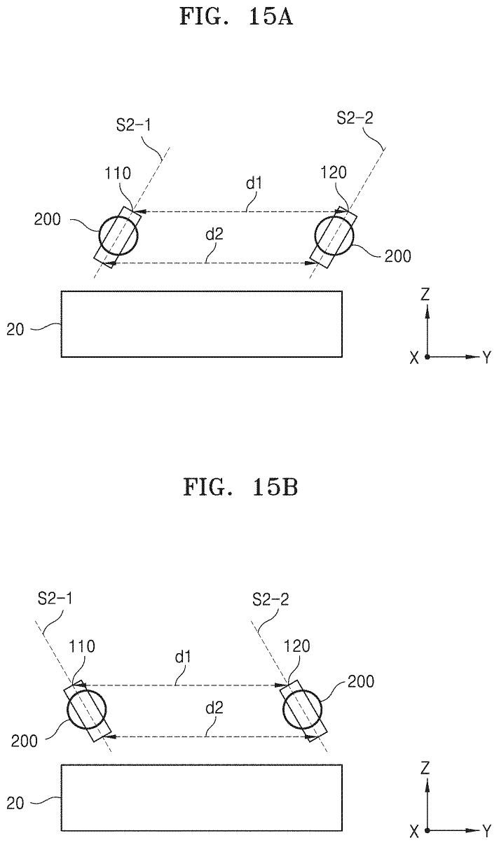

FIG. 13 is a perspective view three-dimensionally illustrating a configuration of a plasma ionizer according to another embodiment of the disclosure, which is an example of a multi-slot structure including two metal plates, FIGS. 14A and 14B are top views schematically illustrating the ionizer of FIG. 13 as viewed from one side and an upper surface, and FIGS. 15A and 15B are side views of an ionizer according to another embodiment of the disclosure as viewed from an YZ plane.

Referring to FIG. 13, an ionizer 1000 may include a source generator 30, a power divider 50, a resonator module 10 and a fan 20, and the resonator module 10 may include two metal plates 100; 110 and 120. Although not illustrated in FIG. 13, a power amplifier 40 may optionally be further interposed between the source generator 30 and the power divider 50.

The power divider 50 may distribute and transmit power to each of the plurality of metal plates 100. In FIG. 13, the power divider 50 may distribute and transmit power to each of the two metal plates 110 and 120 through a transmission conductors 310 and 320.

The resonator module 10 may include a first metal plate 110 and a second metal plate 120 as the two metal plates 100, and the transmission conductor 300; 310 and 320 connected to each of the metal plates 110 and 120.

The first metal plate 110 may include a pair of first long sides Slf-1 and S1m-1; S1-1, a pair of first short sides S2-1 and a slot 150-1. The second metal plate 120 may include a pair of second long sides Slf-2 and S1m-2; S1-2, a pair of second short sides S2-2 and a slot 150-2.

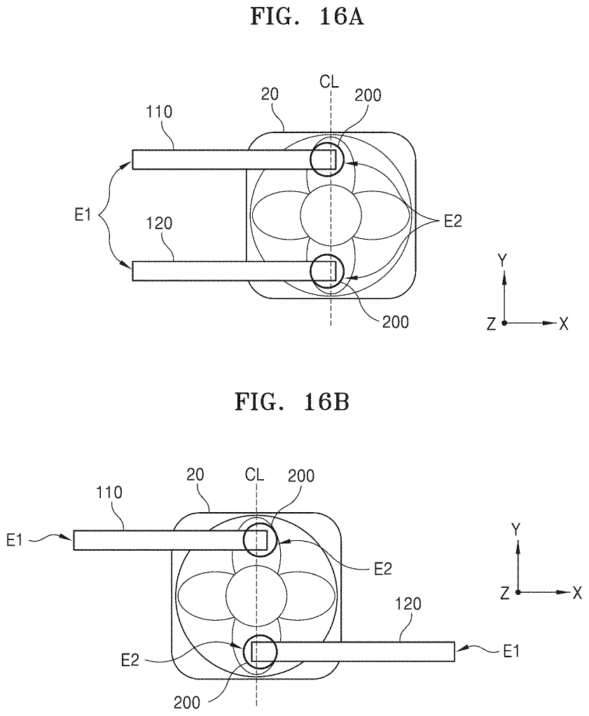

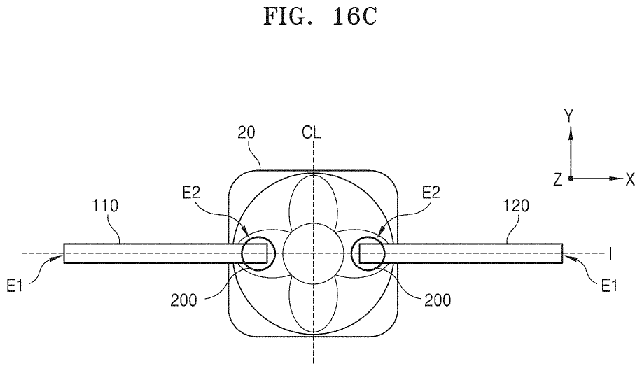

The first metal plate 110 and the second metal plate 120 may be disposed to face each other when viewed in an XY plane. An arrangement on the XY plane of the metal plates 110 and 120 will be described in more detail through FIGS. 16A to 16C to be described later.

The first metal plate 110 includes a 1-1 long side S1f-1 and a 1-2 long side S1m-1 parallel to each other, and the second metal plate 120 may include a 2-1 long side S1f-2 and a 2-2 long side Slm-2 parallel to each other.

At this time, the long sides Slf-1, S1m-1, Slf-2 and S1m-2 of the metal plates 110 and 120 may have an inclination angle of 0 degrees or more and less than 180 degrees with respect to the XY plane. In other words, the long sides of the metal plate 100 may be located on a plane parallel to the XY plane, or may have an inclination angle greater than 0° and less than 180° with the XY plane. On the other hand, the short sides S2-1 and S2-2 of the metal plates 110 and 120 may also have an inclination angle of 0 degrees or more and less than 180 degrees. For example, at least one of the short sides S2-1 and S2-2 may have an inclination angle greater than 0° and less than 180° with a plane parallel to the XY plane. FIG. 13 illustrates an example in which both short sides S2-1 and S2-2 have an inclination angle of about 60 degrees with respect to the XY plane.

FIG. 14A is a side view of the ionizer viewed from a direction crossing an YZ plane (for example, X direction, hereinafter simply YZ plane direction), and FIG. 14B is a top view viewed from a direction crossing an XY plane (For example, Z direction, hereinafter simply XY plane direction). Referencing to FIGS. 14A and 14B together, the short side S2-1 of the first metal plate 110 and the short side S2-2 of the second metal plate 120 may be inclined, so that a distance d1 between 1-2 long side S1m-1 and 2-2 long side 51m-2 is shorter than a distance d2 between 1-1 long side Slf-1 and 2-1 long side Slf-2.

FIGS. 15A and 15B are side views of an ionizer according to another embodiment of the disclosure as viewed from an YZ plane. A first short side S2-1 of a first metal plate 110 and a second short side S2-2 of a second metal plate 120 may be inclined, so that a distance d1 between 1-2 long side S1m-1 and 2-2 long side Slm-2 is equal to a distance d2 between 1-1 long side Slf-1 and 2-1 long side S1f-2. In other words, the two metal plates 110 and 120 may be disposed to be inclined in the same direction when viewed from the YZ plane as illustrated in FIG. 15A or FIG. 15B.

FIGS. 16A to 16C are top views of an arrangement of a metal plate according to different embodiments of the disclosure as viewed from an XY plane. Referring to FIGS. 16A to 16C, each of metal plates 110 and 120 includes a second end E2 in which plasma 200 is generated and a first end E1 opposite and the second end E2, and the second ends E2 may be disposed to face each other in one direction (X direction and/or Y direction in FIGS. 16A to 16C).

FIG. 16A illustrates a top view of the embodiment of FIG. 13. According to the embodiment of FIG. 16A, the first ends E1 of the metal plates 110 and 120 may be disposed on the same side in one direction (X direction in FIGS. 16A to 16C) with respect to a center line CL of the fan 20. According to the embodiment of FIG. 16B, the first ends E1 of the metal plates 110 and 120 may be disposed opposite to each other in one direction (X direction in FIG. 16) with respect to the center line CL of the fan 20. According to the embodiment of FIG. 16C, the first ends E1 and the second ends E2 of the metal plates 110 and 120 may all be arranged to be positioned on a straight line I. In this case, the first ends E1 of the metal plates 110 and 120 may be disposed opposite to each other in one direction (X direction in FIGS. 16A to 16C) with respect to the center line CL of the fan 20.

According to an embodiment, the short sides S2-1 and S2-2 of the metal plates 110 and 120 may be located on a plane parallel to the XY plane.

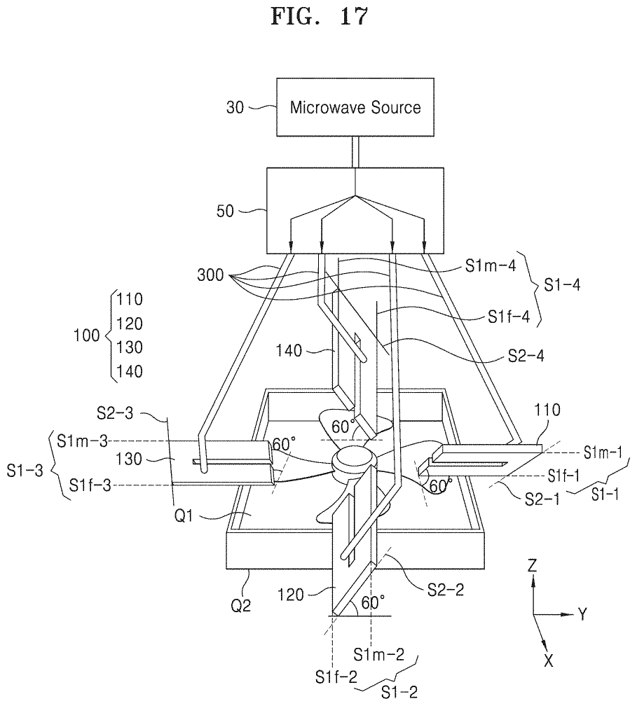

For the embodiments according to the different arrangements of the long side S1 and/or the short side S2 of the metal plates 110 and 120 described above, in order to optimize the performance of the ionizer 1000 according to the situation/environment, as illustrated in FIGS. 16A to 16C, various arrangements viewed in the XY plane of the metal plates 100 may be applied in various combinations. The various arrangements viewed in the XY plane of the metal plates 100 according to FIGS. 16A to 16C may be applied in an appropriate combination regardless of the number of the plurality of metal plates 100 as well as an embodiment in which metal plates 100 is four according to FIG. 17 to be described later.

The signal distributed from the power divider 50 may be supplied to metal plates 110 and 120 connected to each other via the transmission conductors 310 and 320.

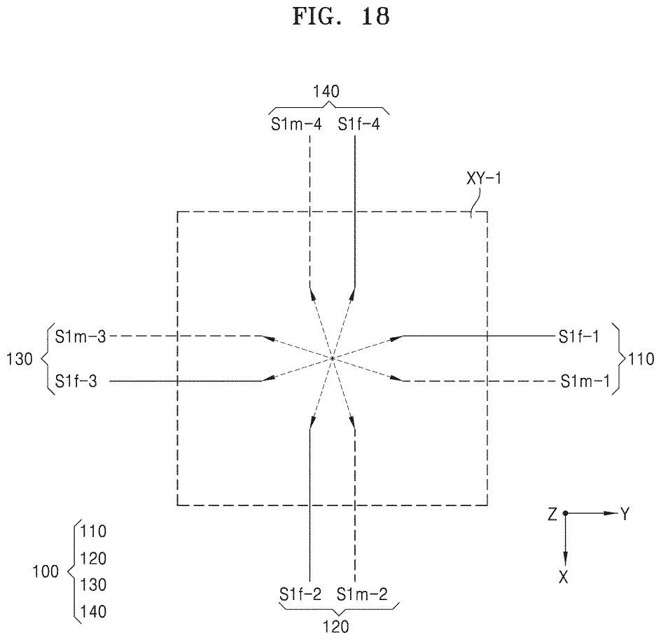

FIG. 17 is a perspective view three-dimensionally illustrating a configuration of a plasma ionizer according to another embodiment of the disclosure, which is another example of a multi-slot structure including four metal plates, and FIG. 18 is a top view schematically illustrating the ionizer of FIG. 17 as viewed from the top.

Referring to FIG. 17, an ionizer 1000 may include a source generator 30, a power divider 50, a resonator module 10 and a fan 20, and the resonator module 10 may include four metal plates 110, 120, 130 and 140; 100. The plurality of metal plates 100 may be arranged to be spaced apart from each other at a predetermined interval and an angle, and at a uniform interval and angle according to an embodiment. Referring to a first metal plate 110 in a clockwise direction, a second metal plate 120, a third metal plate 130 and a fourth metal plate 140 will be named and described. In the case of the embodiment illustrated in FIG. 17, a power amplifier 40 may be further interposed between the source generator 30 and the power divider 50 selectively.

The power divider 50 may distribute and transmit power to the four metal plates 110, 120, 130 and 140 connected to each of the transmission conductor 300 through the transmission conductor 300.

Each of the four metal plates 110, 120, 130 and 140 may include a long side S1-1, S1-2, S1-3 and S1-4; S1, and a short side S2-1, S2-2, S2-3 and S2-4; S2 crossing the long side. The long sides S1 or the short sides S2 of each of the four metal plates 110, 120, 130 and 140 may have an inclination angle of 0 degrees or more and less than 180 degrees.

For example, each of the plurality of metal plates 110, 120, 130 and 140 has a lower long side S1f-1, S1f-2, S1f-3 and S1f-4; S1f and an upper long side S1m-1, S1m-2, S1m-3 and S1m-4; S1m parallel to each other. The upper long side S1m has a certain angle with respect to the lower long side S1f and may determine an inclination angle θ2 of the short side S2. FIG. 17 illustrates an example in which the second inclination angle θ2 is about 60 degrees based on an acute angle, the second inclination angle θ2 is not limited thereto.

Referring to FIG. 18 together, when viewed in an XY plane, the short sides S2-1, S2-2, S2-3 and S2-4; S2 of the plurality of metal plates 100 may be arranged so that the upper long sides S1m-1 and S1m-3 (or the lower long sides S1f-1 and S1f-3) of the pair of metal plates 110 and 130, 120 and 140 facing each other are positioned in opposite directions to each other. For example, the metal plates 110 and 130 may be inclined so that the lower long sides S1f-1 and S1f-3 of the first metal plate 110 and the third metal plate 130 facing each other are located opposite to each other in the X direction. Alternatively, the metal plates 120 and 140 may be inclined so that the lower long sides S1f-2 and S1f-4 of the second metal plate 120 and the fourth metal plate 140 facing each other are positioned opposite to each other in the Y direction.

According to an embodiment, the short sides S2-1, S2-2, S2-3 and S2-4; S2 of the plurality of metal plates 100 may be arranged such that the upper long side S1m (or the lower long side S1f) of the pair of metal plates 110 and 130, 120 and 140 facing each other are located in the same direction.

The inclination angle of the short sides S2 of the plurality of metal plates 100 is not limited thereto, relationships of the inclination angle of the short sides S2 of the plurality of metal plates 100 may be appropriately combined so that the antistatic performance of the ionizer 1000 may be optimized, such as the upper long side S1m (or the lower long side S1f) of the pair of metal plates 110 and 130 are located in opposite directions to each other, and the upper long side S1m (or the lower long side S1f) of the other pair of metal plates 120 and 140 are positioned in the same direction.

Even when the resonator module 10 has the multi-slot structure, the fan 20 includes a first surface Q1 and a second surface Q2 that are parallel to the XY plane and face each other, and the wind blows from the first surface Q1 toward the lower surface of the second surface Q2, and the metal plates 100 may be positioned above the first surface Q1 of the fan 20. By placing the metal plates 100 in front of the fan 20, the effect of wind on the plasma 200 generated on the metal plate 100 may be minimized to optimize the antistatic performance of the ionizer 1000.

In the above, it has been described that the ionizer 1000 includes two or four metal plates 100 when it has the multi-slot structure as an example, but the number of the plurality of metal plates 100 included in the resonator module 10 is not limited thereto.

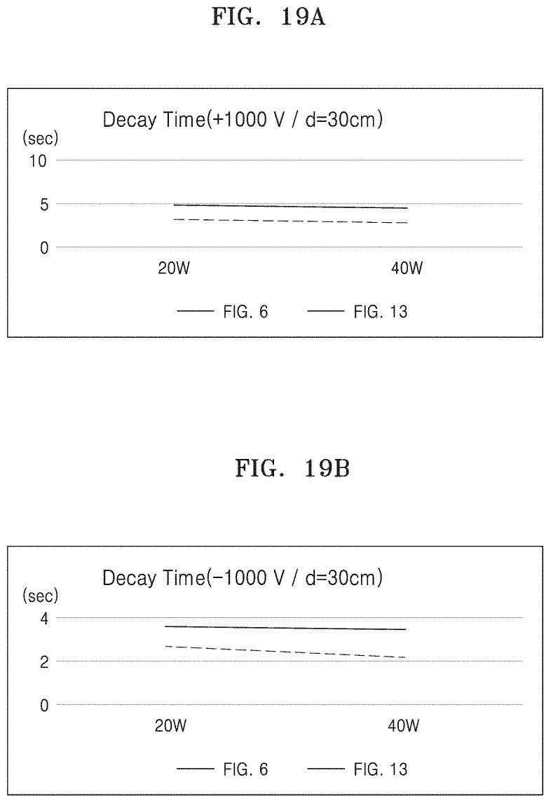

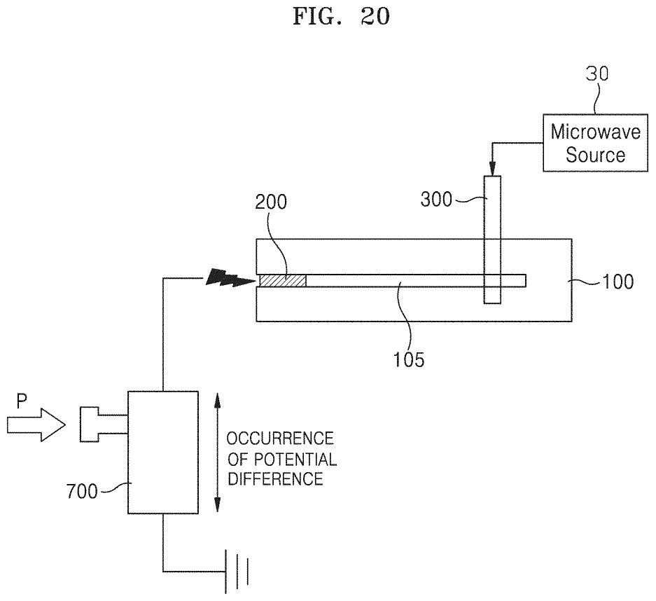

FIGS. 19A and 19B are graphs comparing and measuring decay times with respect to the embodiments of FIG. 6 (single slot electrode) and FIG. 13 (multi-slot electrode). FIGS. 19A and 19B are graphs measuring decay times when powers of 20 W and 40 W are supplied, respectively, based on a distance d between the metal plate 100 and the plate of the CPM device 61 of 30 cm.

When the initial constant voltage is +1000 V, −1000 V, the decay time when the multi-slot structure including two metal plates 100 is smaller than that when the single metal plate 100 is included, confirming that the antistatic performance is better.

In each of the above-described embodiments of the disclosure, the angle formed by the long side and/or the short side of the metal plate with the XY plane may be variously adjusted, and thus may be set to an angle to give the optimal performance.

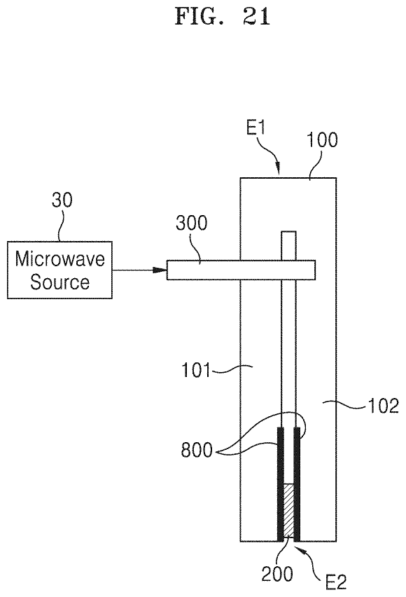

Hereinafter, embodiments related to another method of igniting plasma will be described with reference to FIGS. 20 and 21. FIGS. 20 and 21 are each schematically illustrating a configuration of a plasma ionizer according to another embodiment of the disclosure. Hereinafter, descriptions of contents overlapping with the above-described contents will be omitted, and a characteristic configuration will be mainly described.

Referring to FIG. 20, a source generator 30, a transmission conductor 300 and a metal plate 100 in which plasma 200 is generated on a slot 105 of an ionizer 1000 are illustrated. The ionizer 1000 may further include a piezoelectric element 700 disposed at one end of the metal plate 100. Although not illustrated in the drawing, a power amplifier and/or a power divider may be further disposed between the source generator 30 and the transmission conductor 300.

When a pressure P is applied to the piezoelectric element 700, a potential difference is generated at both ends of the piezoelectric element 700. One end of the piezoelectric element 700 is grounded, and the other end of the piezoelectric element 700 may be disposed adjacent to one end of the metal plate 100 at which plasma 200 is generated. When the pressure P is applied to the piezoelectric element 700, the plasma 200 may be ignited by the instantaneous potential difference compared to the grounded end. In this case, plasma 200 may be ignited without inert gas such as argon gas.

Referring to FIG. 21, a metal plate 100 includes a first electrode 101 and a second electrode 102 facing each other with a slot 105 interposed therebetween. In this case, each of the first electrode 101 and the second electrode 102 is adjacent to the slot 105, and the metal plate 100 may further include a material layer 800 coated on one end E2 opened by the slot 105. The material layer 800 may include graphite. As such, by coating the material layer such as graphite with high electrical conductivity, self-ignition of plasma 200 may be enabled without inert gas such as argon gas.

As such, according to an embodiment of the disclosure, it is possible to implement a plasma ionizer 1000 capable of igniting plasma without inert gas through various methods such as using an additional stimulus (e.g., pressure, etc.) or a conductive material.

In the above, a preferred embodiment of the disclosure has been illustrated and described, but the disclosure is not limited to the above-described specific embodiment, and, without departing from the gist of the disclosure as claimed in the claims, various modifications may be made by those of ordinary skill in the technical field to which the disclosure pertains, in addition, these modified implementations should not be individually understood from the technical spirit or prospect of this disclosure.

Therefore, the spirit of the disclosure should not be limited to the embodiments described above, and it will be said that not only the claims described later, but also all ranges equivalently or equivalently changed to the claims fall within the scope of the spirit of the disclosure.

What is claimed is:

1. A plasma ionizer comprising:
a resonator module comprising a metal plate and configured to generate plasma by using an electric field, wherein the metal plate comprises a long side extending in a longitudinal direction, a short side crossing the long side, and a slot extending in the longitudinal direction;
a source generator connected to the resonator module, and configured to supply a signal to the resonator module to generate plasma including plasma ions around the metal plate; and
a fan placed in an XY plane, and configured to move the plasma ion in a direction crossing the XY plane.

2. The plasma ionizer of claim 1, wherein:
the fan comprises a first surface parallel to the XY plane, and a second surface parallel to the XY plane and facing the first surface,
a wind generated by the fan is configured to blow downward of the second surface from the first surface, and
the metal plate is located above the first surface of the fan.

3. The plasma ionizer of claim 1, further comprising a power divider, wherein:
the resonator module comprises a plurality of the metal plates, and
the power divider is configured to distribute and transmit the signal to each of the plurality of metal plates.

4. The plasma ionizer of claim 3, wherein:
the plurality of metal plates comprise a first metal plate and a second metal plate,
the first metal plate comprises a first long side and a first short side crossing the first long side, the second metal plate comprises a second long side and a second short side crossing the second long side, and
an extension line of the first short side and an extension line of the second short side each have an inclination angle of 0 degrees or more and less than 180 degrees with respect to the XY plane.

5. The plasma ionizer of claim 3, wherein:
the plurality of metal plates comprise four metal plates spaced apart from each other at a predetermined interval,
each of the four metal plates comprises a long side and a short side crossing the long side, and
extension lines of the short sides of each of the four metal plates have an inclination angle of 0 degrees or more and less than 180 degrees with respect to the XY plane.

6. The plasma ionizer of claim 1, further comprising a piezoelectric element disposed on one end of the metal plate, wherein the plasma is configured to be ignited by applying a pressure to the one end through the piezoelectric element.

7. The plasma ionizer of claim 1, wherein the metal plate comprises a first electrode and a second electrode facing each other with the slot therebetween, and a conductive material layer coated on one end of each of the first electrode and the second electrode adjacent to the slot.
